(19) United States
(12) Patent Application Publication
(10) Pub. No.: US 2025/0095252 A1
(43) Pub. Date: Mar. 20, 2025

(54) CONTENT GENERATION METHOD, COMPUTER DEVICE, AND STORAGE MEDIUM

(71) Applicant: Beijing Zitiao Network Technology Co., Ltd., Beijing (CN)

(72) Inventors: Aijing BAI, Beijing (CN); Dongxing JIA, Beijing (CN)

(21) Appl. No.: 18/796,330

(22) Filed: Aug. 7, 2024

(30) Foreign Application Priority Data
Sep. 15, 2023 (CN) 202311199451.8

(51) Int. Cl. G06T 11/60; G06F 40/30

(52) U.S. Cl. CPC G06T 11/60; G06F 40/30

(57) ABSTRACT

The present disclosure provides a cluster management method, electronic device and storage medium. The content generation method includes: acquiring a target text, wherein the target text comprises description content for describing a target role and/or a target scenario; generating a prompt word based on the target text, wherein the prompt word includes: a role prompt word corresponding to the target role and/or a scenario prompt word corresponding to the target scenario; inputting the prompt word into a content generation model, and generating at least one frame of preview image corresponding to the target text; in response to a first modification operation on a prompt word associated with a first preview image, inputting a modified prompt word into the content generation model, and generating a new preview image corresponding to the first preview image; generating target multimedia content corresponding to the target text based on the new preview image.

### CROSS-REFERENCE TO RELATED APPLICATION

This application claims the priority to and benefits of the Chinese Patent Application, No. 202311199451.8, which was filed on Sep. 15, 2023. The aforementioned patent application is hereby incorporated by reference in its entirety.

### TECHNICAL FIELD

The present disclosure relates to the field of computer application technologies, and specifically, to a content generation method and apparatus, a computer device, and a storage medium.

### BACKGROUND

With the continuous rise of We Media, rapid generation of content has also become current urgent requirements of many users. Generating content by using a neural network model is an important manner of quickly generating content at present. The pre-trained neural network model can generate corresponding multimedia content based on text information input by a user.

In the current manner of generating the content based on the neural network model, the user is required to provide corresponding text content according to a fixed format, and then input the text content into the neural network model. The neural network model outputs corresponding multimedia content directly based on the text content after receiving the text content. If the user needs to modify the multimedia content output by the neural network model, the input text content needs to be adjusted, and controllability of the generation process is poor.

### SUMMARY

The embodiments of the present disclosure at least provide a content generation method, an apparatus, a computer equipment, and a storage medium.

In a first aspect, an embodiment of the present disclosure provides a content generation method, and the content generation method comprises:

acquiring a target text, wherein the target text comprises description content for describing a target role and/or a target scenario;

generating a prompt word based on the target text, wherein the prompt word comprises: a role prompt word corresponding to the target role and/or a scenario prompt word corresponding to the target scenario;

inputting the prompt word into a content generation model, and generating at least one frame of preview image corresponding to the target text, wherein prompt words associated with different preview images are at least partially different;

in response to a first modification operation on a prompt word associated with a first preview image, inputting a modified prompt word into the content generation model, and generating a new preview image corresponding to the first preview image, wherein the first preview image is any one frame of the at least one frame of preview image; and

generating target multimedia content corresponding to the target text based on the new preview image.

In one possible implementation, wherein the generating a prompt word based on the target text, comprises:

splitting the target text to obtain a plurality of text segments, wherein any text segment comprises: at least part of a first description content for the target role, and/or at least part of a second description content for the target scenario; and

for each text segment of the plurality of text segments, performing semantic analysis on each text segment to obtain a prompt word corresponding to each text segment.

In one possible implementation, wherein the inputting the prompt word into a content generation model, and generating at least one frame of preview image corresponding to the target text, comprises:

inputting prompt words respectively corresponding to the plurality of text segments into the content generation model, to obtain a preview image corresponding to each text segment.

In one possible implementation, wherein the in response to a first modification operation on a prompt word associated with a first preview image, inputting a modified prompt word into the content generation model, and generating a new preview image corresponding to the first preview image, comprises:

in response to a first modification operation on a prompt word associated with any text segment, inputting a modified prompt word corresponding to the any text segment into the content generation model, and generating a new preview image corresponding to the any text segment.

In one possible implementation, the content generation method further includes:

determining an associated preview image from other preview images other than the first preview image based on the modified prompt word corresponding to the any text segment; and

modifying the associated preview image based on the modified prompt word corresponding to the any text segment, to obtain a new preview image corresponding to the associated preview image.

In one possible implementation, wherein before the generating target multimedia content corresponding to the target text based on the new preview image, the content generation method further comprises:

generating caption information corresponding to the target text, and/or

determining a target timbre corresponding to the target text; and

the generating target multimedia content corresponding to the target text based on the new preview image, comprises:

generating the target multimedia content corresponding to the target text based on the new image and at least one selected from a group consisting of the caption information and the target timbre.

In one possible implementation, wherein the determining a target timbre corresponding to the target text, comprises:

determining a sound feature of the target role based on the target text, and matching a corresponding target timbre for the target role based on the sound feature; or,

receiving a target timbre determined by a user from a plurality of candidate timbres.

In one possible implementation, the content generation method further comprises:

acquiring painting style information and/or image ratio information of the preview image; and

the inputting the prompt word into a content generation model, and generating at least one frame of preview image corresponding to the target text, comprises:

inputting the prompt word and at least one selected from the group consisting of the painting style information and the image ratio information into the content generation model, and generating the at least one frame of preview image corresponding to the target text.

In one possible implementation, wherein before the generating at least one frame of preview image corresponding to the target text, the method further comprises:

obtaining appearance feature information corresponding to the target role, wherein the appearance feature information is obtained by performing role feature analysis on the target text, and/or receiving the appearance feature information corresponding to the target role input by a user;

inputting the appearance feature information into the content generation model, to obtain a role image of the target role; and

the inputting the prompt word into a content generation model, and generating at least one frame of preview image corresponding to the target text, comprising:

inputting the prompt word and the role image into the content generation model to generate the at least one frame of preview image corresponding to the target text.

In one possible implementation, the content generation method further comprises:

in response to a second modification operation on the appearance feature information corresponding to the target role, generating a new role image of the target role based on a modified appearance feature information;

determining a preview image corresponding to the target role from a plurality of preview images; and

modifying the target role in the preview image corresponding to the target role based on the new role image, to obtain a second preview image;

the generating target multimedia content corresponding to the target text based on the new preview image, comprising:

generating the target multimedia content corresponding to the target text based on the second preview image and the new preview image.

In a second aspect, the present disclosure also provides a content generation apparatus, which comprises:

an obtaining module, configured to acquire a target text, wherein the target text comprises description content for describing a target role and/or a target scenario;

a first generation module, configured to generate a prompt word based on the target text, wherein the prompt word comprises: a role prompt word corresponding to the target role and/or a scenario prompt word corresponding to the target scenario;

a second generation module, configured to input the prompt word into a content generation model, and generating at least one frame of preview image corresponding to the target text, wherein prompt words associated with different preview images are at least partially different;

a modification module, configured to, in response to a first modification operation on a prompt word associated with a first preview image, input a modified prompt word into the content generation model, and generating a new preview image corresponding to the first preview image, wherein the first preview image is any one frame of the at least one frame of preview image; and

a third generation module, configured to generate target multimedia content corresponding to the target text based on the new preview image.

In one possible implementation, when the second generation module inputs the prompt word into a content generation model, and generating at least one frame of preview image corresponding to the target text, the second generation module is configured to:

input prompt words respectively corresponding to the plurality of text segments into the content generation model, to obtain a preview image corresponding to each text segment.

In one possible implementation, when the modification module, in response to a first modification operation on a prompt word associated with a first preview image, inputs a modified prompt word into the content generation model, and generates a new preview image corresponding to the first preview image, the modification module is configured to:

in response to a first modification operation on a prompt word associated with any text segment, input a modified prompt word corresponding to the any text segment into the content generation model, and generate a new preview image corresponding to the any text segment.

In one possible implementation, the modification module is further configured to: determine an associated preview image from other preview images other than the first preview image based on the modified prompt word corresponding to the any text segment; and

modify the associated preview image based on the modified prompt word corresponding to the any text segment, to obtain a new preview image corresponding to the associated preview image.

In one possible implementation, the apparatus further comprises a processing module, and the processing module is configured to generate caption information corresponding to the target text, and/or determine a target timbre corresponding to the target text. In one possible implementation,

When the third generation module generates target multimedia content corresponding to the target text based on the new preview image, the third generation module is configured to:

generate the target multimedia content corresponding to the target text based on the new image and at least one selected from a group consisting of the caption information and the target timbre.

In one possible implementation, when the processing module determines a target timbre corresponding to the target text, the processing module is configured to:

determine a sound feature of the target role based on the target text, and match a corresponding target timbre for the target role based on the sound feature; or,

receive a target timbre determined by a user from a plurality of candidate timbres.

In one possible implementation, the processing module is further configured to:

acquiring painting style information and/or image ratio information of the preview image;

when the second generation module inputs the prompt word into a content generation model, and generates at least one frame of preview image corresponding to the target text, the second generation module is configured to:

inputs the prompt word and at least one selected from the group consisting of the painting style information and the image ratio information into the content generation model, and generates the at least one frame of preview image corresponding to the target text.

In one possible implementation, the apparatus further comprises a fourth generation module, which is configured to:

obtain appearance feature information corresponding to the target role, wherein the appearance feature information is obtained by performing role feature analysis on the target text, and/or receive the appearance feature information corresponding to the target role input by a user;

when the second generation module inputs the appearance feature information into the content generation model, to obtain a role image of the target role, the second generation module is configured to:

input the prompt word and the role image into the content generation model to generate the at least one frame of preview image corresponding to the target text.

In a third aspect, an optional implementation of the present disclosure further provides a computer device, a processor, and a memory, wherein the memory stores machine-readable instructions executable by the processor, and the processor is configured to execute the machine-readable instructions stored in the memory, and when the machine-readable instructions are executed by the processor, the machine-readable instructions are executed by the processor to perform the steps of the first aspect or any possible implementation of the first aspect.

In a fourth aspect, an optional implementation of the present disclosure further provides a non-transient computer-readable storage medium, wherein a computer program is stored on the non-transient computer-readable storage medium, and when the computer program is executed, the steps of the first aspect or any possible implementation of the first aspect are executed.

For descriptions of the effect of the content generation apparatus, the computer device, and the computer-readable storage medium, refer to the content generation method, and details are not described herein again.

It should be understood that, the foregoing general descriptions and the following detailed descriptions are merely exemplary and explanatory, and are not intended to limit the technical solutions of the present disclosure.

In order to make the foregoing objectives, features and advantages of the present disclosure more obvious and understandable, the following provides detailed descriptions by using preferred embodiments in cooperation with the accompanying drawings.

It should be understood that the above general description and the detailed description below are only exemplary and explanatory, and do not limit the technical solution of the present disclosure.

### BRIEF DESCRIPTION OF DRAWINGS

In order to make the above-mentioned purposes, features and advantages of the present disclosure more obvious and easier to understand, the following is a detailed description of the preferred embodiments in conjunction with the attached drawings as follows.

In order to more clearly describe the technical solutions of embodiments of the present disclosure, the following briefly describes the accompanying drawings to be used in embodiments. The accompanying drawings herein are incorporated in this specification and form a part of this specification, show embodiments consistent with the present disclosure, and are used together with this specification to describe the technical solutions of the present disclosure. It should be understood that the following accompanying drawings show only some embodiments of the present disclosure, and therefore should not be regarded as limiting the scope, and a person of ordinary skill in the art may further obtain other relevant accompanying drawings from these accompanying drawings without creative efforts.

FIG. 1 is a flowchart of a content generation method according to some embodiments of the present disclosure;

FIG. 2 is a first example of an interactive control page according to some embodiments of the present disclosure;

FIG. 3 is a flowchart of generating a prompt word based on target text according to some embodiments of the present disclosure;

FIG. 4 is a second example of an interactive control page according to some embodiments of the present disclosure;

FIG. 5 is a schematic diagram of an interactive control apparatus according to some embodiments of the present disclosure; and

FIG. 6 is a schematic diagram of a computer device according to some embodiments of the present disclosure.

### DETAILED DESCRIPTION

To make the objectives, technical solutions, and advantages of embodiments of the present disclosure clearer, the following clearly and completely describes the technical solutions in embodiments of the present disclosure with reference to the accompanying drawings in embodiments of the present disclosure. Apparently, the described embodiments are merely some rather than all of the embodiments of the present disclosure. The components in embodiments of the present disclosure described and shown herein may be usually arranged and designed in a variety of different configurations. Therefore, the following detailed descriptions of embodiments of the present disclosure are not intended to limit the scope of the present disclosure for which protection is claimed, but rather represents only selected embodiments of the present disclosure. Based on embodiments of the present disclosure, all other embodiments obtained by a person skilled in the art without creative efforts fall within the protection scope of the present disclosure.

It is found through research that, there are usually the following two manners of generating multimedia content by using a neural network model at present:

First, a user inputs text information. The neural network model performs feature extraction on the text information, to obtain feature data corresponding to the text information; and then matches corresponding target materials for the text information from a pre-constructed material library according to the feature data, and organizes matched target materials together in a particular manner, to obtain the multimedia content corresponding to the text information. Quality of the multimedia content generated in this generation manner usually depends on richness of the material library, and the degree of matching between the generated multimedia content and the text information is usually low.

Second, the user inputs the text information. The neural network model performs feature extraction on the text information, and directly generates a picture based on extracted features. Quality of the multimedia content generated in this manner usually depends on the text information input by the user. To meet a requirement of the user, the user is usually required to input multidimensional description information, to generate corresponding multimedia content. Once the user misses some information, or is not satisfied with current multimedia content, the user needs to further modify the generated multimedia content, and needs to re-input the text information, and generates multimedia content by using the neural network model. As a result, controllability of the process of generating the multimedia content is poor, and generation efficiency is low.

Based on the foregoing research, the present disclosure provides a content generation method, to improve reliability of the process of generating multimedia content, and improve generation efficiency. In addition, there is a higher degree of matching between the generated multimedia content and the text information that is input by the user.

The defects that exist in the foregoing solutions are all results of the inventor's practice and careful study. Therefore, the process of discovery of the foregoing problems and the solutions proposed in the present disclosure hereinafter for the foregoing problems should be the inventor's contribution to the present disclosure in the process of the present disclosure.

It should be noted that similar reference numerals and letters indicate similar items in the following accompanying drawings, so that once an item is defined in one accompanying drawing, it does not need to be further defined and explained in subsequent accompanying drawings.

It may be understood that before the technical solutions disclosed in embodiments of the present disclosure are used, the user should be informed of the type of personal information involved in the present disclosure, the scope of use, use scenarios, and the like in a proper manner in accordance with the relevant laws and regulations, and authorization of the user should be obtained. For example, prompt information for requesting authorization may be specifically sent to the user in a manner of popup or information push in a page. After the user agrees, the foregoing information is used.

To facilitate the understanding of this embodiment, a content generation method disclosed in this embodiment of the present disclosure is first described in detail, and an execution body of the content generation method provided in this embodiment of the present disclosure is generally a computer device having a particular computing capability. The computer device includes, for example, a terminal device, a server, or another processing device, and the terminal device may be user equipment (User Equipment (User Equipment, UE), a mobile device, a user terminal, a terminal, a cellular telephone, a cordless telephone, a personal digital assistant (Personal Digital Assistant, PDA), a handheld device, a computing device, a vehicle-mounted device, a wearable device, or the like. In some possible implementations, the content generation method may be implemented by a processor by invoking a computer-readable instruction stored in a memory.

The following describes the content generation method provided in this embodiment of the present disclosure.

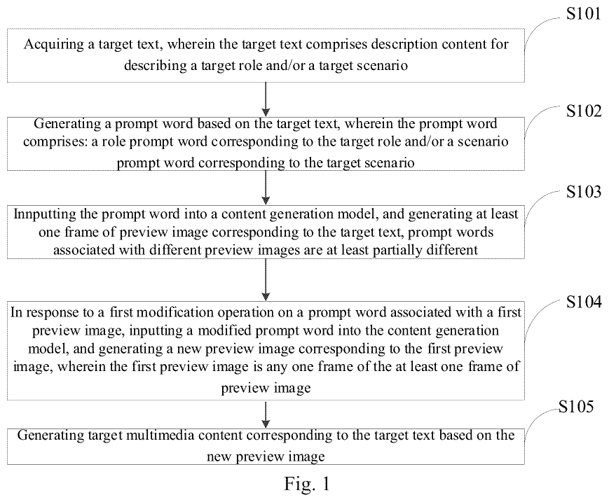

FIG. 1 is a flowchart of a content generation method according to an embodiment of the present disclosure. The method includes steps S101 to S105.

S101: Acquiring a target text, wherein the target text includes description content for describing a target role and/or a target scenario.

S102: Generating a prompt word based on the target text, wherein the prompt word includes: a role prompt word corresponding to the target role and/or a scenario prompt word corresponding to the target scenario.

S103: Inputting the prompt word into a content generation model, and generating at least one frame of preview image corresponding to the target text, wherein prompt words associated with different preview images are at least partially different.

S104: In response to a first modification operation on a prompt word associated with a first preview image, inputting a modified prompt word into the content generation model, and generating a new preview image corresponding to the first preview image, wherein the first preview image is any one frame of the at least one frame of preview image.

S105: Generating target multimedia content corresponding to the target text based on the new preview image.

In this embodiment of the present disclosure, after the target text is obtained, the prompt word is generated based on the target text. The prompt word includes the role prompt word corresponding to the target role and/or the scenario prompt word corresponding to the target scenario. Then, the prompt word is input into the content generation model, to generate the at least one frame of preview image corresponding to the target text. Because the prompt words associated with different preview images are at least partially different, if the user needs to modify a particular frame of preview image, the user only needs to perform a first modification operation on a prompt word corresponding to the frame of preview image, and inputs a modified prompt word into the content generation model, to generate a new preview image corresponding to the frame of preview image, to further improve controllability of the process of generating multimedia content, and improve content generation efficiency.

In addition, in this embodiment of the present disclosure, the prompt word is directly input into the content generation model, so that the content generation model can directly generate a preview image according to the prompt word, and there is a higher degree of matching between the generated preview image and the prompt word. Compared with a manner of splicing to obtain multimedia content by using existing materials in the prior art, the multimedia content generated by using the content generation model based on the prompt word in this embodiment of the present disclosure has a higher degree of matching with the target text.

The foregoing S101 to S104 are separately described in detail below.

For the foregoing S101:

the target text may include, for example, a novel, a script, or text content generated based on conversion of any form of performance such as a song, a comic dialogue, a stage play, a movie or a television show or other multimedia content with audio or captions.

When target texts are different, uses and categories of generated target multimedia content are also different.

For example, when the target text includes a novel, the generated multimedia content includes, for example, any one of: an illustration of the novel, an animated video corresponding to the novel, an explanatory video, and the like.

For cases where the target text includes a script, the generated multimedia content includes, for example, a storyboard for the script of the script, or a simple animation or video that corresponds to the script and that can be understood more intuitively by the actors.

For cases where the target text includes a song, the multimedia content generated includes, for example, a music video (Music Video, MV) of the song, a cover of the song release, a promotional poster, and the like.

For cases where the target text includes a comic dialogue, a stage play, a movie or a television show, or the like, the generated multimedia content includes, for example, a poster, a content trailer, a commentary video, or the like for any of the foregoing forms of performance.

The target text usually includes the description content for describing the target role and/or the target scenario.

The description content corresponding to the target role may include, for example, content for describing an appearance, a behavior, an identity, a personality, emotions, and the like of the target role.

The content for describing the target scenario includes, for example, content for describing a type, a scenery, a layout, time, weather, an event, and the like of the target scenario.

The target text may include only the content for describing the target role, or may include only the content for describing the target scenario, or may include both.

In a possible implementation, when the target text includes the content for describing the target role and the target scenario, the target scenario includes, for example, a scenario in which the target role is located.

In addition, in another possible implementation, a specific manner of obtaining the target text is further provided, including:

displaying an interactive control page, where the interactive control page includes an input control configured to receive the target text, and the input control includes: a text input box, a text import button, and a confirmation button;

jumping to a target page in response to a trigger operation on the text import button, and importing text content in the target page into the text input box; and

using the text content in the text input box as the target content in response to a trigger operation on the confirmation button.

In addition, the text content may alternatively be input in the text input box by using an input device, and the input text content is used as the target text.

In this embodiment, the target page includes, for example, a novel content display page corresponding to a reading application, an editing page corresponding to a text editing program, or the like. When applications are different, target pages are also different.

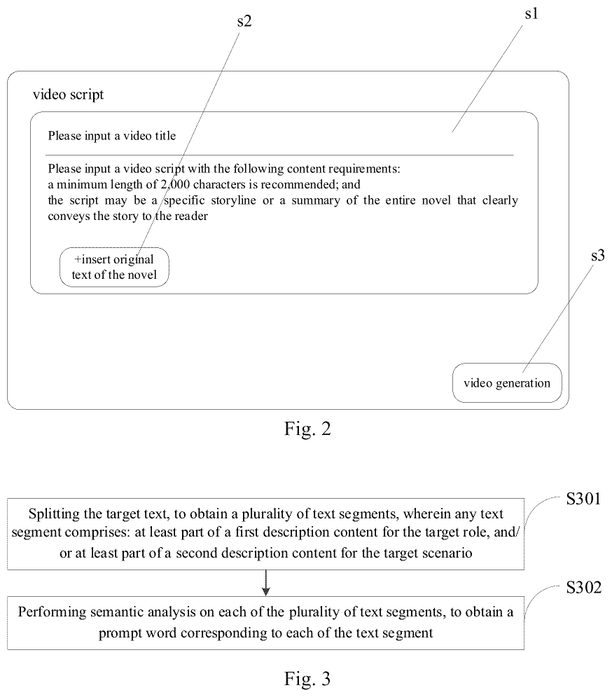

As shown in FIG. 2, an embodiment of the present disclosure further provides a specific example of an interactive control page. The interactive control page includes: a text input box s1, a text import button s2, and a confirmation button s3.

When no text content is written in the text input box s1, prompt information of the target text is displayed to the user. In this example, the prompt information includes, for example, “please input a video title” and “please input a video script with the following content requirements: a minimum length of 2,000 characters is recommended; the script may be a specific storyline or a summary of the entire novel that clearly conveys the story to the reader.” To prompt the user to enter specific target content.

In addition, the user may jump to the target page through the text import button s2, and directly import the text information included in the target page into the text input box s1. After the text information is imported into the text input box s1, the user may further modify the text information in the text input box s1. After confirming that the text information in the text input box is correct, the user may tap the confirmation button s3, to enable the device performing the content generation method provided in this embodiment of the present disclosure to obtain the target text.

For the foregoing S102:

during specific implementation, generating the prompt word (prompt) based on the target text may be, for example, performing keyword extraction on the target text to obtain the prompt word, or may be summarizing content in the target text to obtain the prompt word. The prompt word may occur in the target text, or may not occur in the target text, but can represent, to some extent, content described in the target text.

The role prompt word includes words that describe the target role in a plurality of role description dimensions, and can represent features of the target role in the plurality of role description dimensions. The plurality of role description dimensions include, for example, at least one selected from the group consisting of gender, age, appearance, actions, identity, personality, and emotions.

The scenario prompt word includes, for example, words that describe the target scenario in a plurality of scenario description dimensions, and can represent features of the target scenario in the plurality of scenario description dimensions. The plurality of scenario description dimensions include, for example, a type, a scenery, a layout, time, weather, an event, and the like of the target scenario.

FIG. 3 further provides another specific method for generating a prompt word based on target text, and the method includes:

S301: Splitting the target text, to obtain a plurality of text segments, wherein any text segment includes: at least part of a first description content for the target role, and/or at least part of a second description content for the target scenario.

During specific implementation, the target text may be split, for example, in at least one of the following manners:

a1: splitting the target text based on punctuations included in the target text, to obtain a plurality of text segments.

For example, the target text is usually formed of a plurality of sentences, and the punctuations can present mutual relationships between the sentences. For example, two sentences that are linked by a comma usually represent meanings that have a strong correlation with each other, and two sentences that are linked by a full stop usually represent meanings that have weak correlation with each other. Further, in this embodiment of the present disclosure, when the target text is split based on the punctuations included in the target text, for example, a target punctuation corresponding to a splitting position may be determined according to a particular splitting granularity, and then the target text is split into the plurality of text segments based on the punctuations included in the target text.

Herein, the splitting granularity may be, for example, predetermined by the user, or determined according to a specific condition of target multimedia content generated by the user.

For example, for a case where the splitting granularity is large, for example, a full stop may be used as the target punctuation to split the target text; and for a case where the splitting granularity is small, for example, a comma and a full stop may be used as the target punctuations to split the target text. In addition, a larger splitting granularity may also be set. For example, when the target text includes a plurality of paragraphs, the target text may also be split at the splitting granularity of paragraphs.

In addition, the splitting granularity may also be adaptively determined for the target text based on at least one selected from the group consisting of a data volume included in the target text, video duration in the generated target multimedia content, and a frame refresh rate of images in the generated target multimedia content.

For example, the size of the splitting granularity in the target multimedia content is negatively correlated with the duration of the generated target multimedia content. To be specific, for a particular target text, when a text length of the target text does not change, longer duration of to-be-generated target multimedia content indicates a smaller splitting granularity, to ensure that more text segments can be obtained, thereby generating more preview images.

The size of the splitting granularity of the target multimedia content is positively correlated with the data volume included in the target text. To be specific, when the target text includes a larger data volume, in some cases, to control the data volume of the generated target multimedia content, a larger splitting granularity may be set for the target text, to ensure that a suitable quantity of preview images can be generated.

The size of the splitting granularity is negatively correlated with the frame refresh rate of the images in the target multimedia content. To be specific, for a particular target text, when the text length of the target text does not change, a higher frame refresh rate of the images in the to-be-generated target multimedia content indicates a larger quantity of required preview images, and further indicates a smaller splitting granularity for splitting the target text, to ensure that a maximum quantity of preview images can be obtained, thereby meeting the requirement of the frame refresh rate.

In this embodiment of the present disclosure, the duration and the frame refresh rate of the target multimedia content may both be used as user-controllable input parameters in the process of generating the target multimedia content, to provide more refined control over generation of the target multimedia content, thereby meeting the requirement of the user.

a2: splitting the target text based on a target quantity interval.

Herein, for example, the user may set a specific target quantity interval. The target quantity interval represents an interval of a quantity of words included in each text segment.

One text segment may include at least one sentence, and a quantity of all words included in the text segment belongs to the target quantity interval.

a3: performing keyword extraction on the target text, to obtain a keyword sequence included in the target text. Then, keywords are first grouped according to the keywords included in the keyword sequence, where different keywords that belong to a same group are usually adjacent in the keyword sequence; and then sentences in which different keywords in a same group are respectively located are divided into a same text segment according to specific positions of the keywords in the target text.

When the plurality of keywords included in the keyword sequence are grouped, for example, sentences to which the keywords belong may be respectively marked for the keywords. During grouping, a correlation between two adjacent sentences may be determined based on keywords in the two adjacent sentences. If the correlation between two adjacent sentences is greater than a particular correlation threshold, it indicates that the two adjacent sentences describe a same scenario or a same event. In this case, keywords respectively included in the two adjacent sentences may be divided into a same group.

In addition, the target text may also be divided into text segments in another manner. Details are not described again in this embodiment of the present disclosure.

S302: Performing semantic analysis on each of the plurality of text segments, to obtain a prompt word corresponding to each of the text segment.

Herein, any text segment may include only at least one part of the first description content of the target role, in this case, an obtained prompt word corresponding to the text segment includes only the role prompt word. Herein, the first description content of the target role may be included in a plurality of text segments. In this case, a particular text segment may include only a part of the first description content of the target role. If the first description content of the target role is included in one text segment, the text segment includes all the first description content of the target role.

In any of the text segment, only at least one part of the second description content may also be included. Further, a prompt word corresponding to the any text segment includes only the scenario prompt word. Similarly, the second description content of the target scenario may be included in a plurality of text segments. In this case, a particular text segment may include only a part of the second description content of the target scenario. If the second description content of the target scenario is included in one text segment, the text segment includes all the second description content of the target scenario.

In addition, the any text segment may further include both the at least part of the first description content of the target role and the at least part of the second description content of the target scenario. Further, the prompt word corresponding to the text segment may include the role prompt word and the scenario prompt word.

When semantic analysis is performed on the text segment, for example, the text segment may be input to a pre-trained neuro-linguistic programming (Neuro-Linguistic Programming, NLP), to obtain a prompt word corresponding to each text segment.

For the foregoing S103:

after the prompt word is obtained, the prompt word may be input into the content generation model, to generate at least one frame of preview image corresponding to the target text. Prompt words associated with different preview images are at least partially different.

In a possible implementation, in response to directly performing keyword extraction or semantic analysis on the target text, to obtain prompt words, for example, a sequence of the prompt words may be formed according to a content description logic of the target text, and then the prompt words are input into the content generation model according to the sequence. When generating preview images, a semantic generation module, for example, may sequentially generate a plurality of preview images according to the sequence formed by the prompt words. Prompt words respectively corresponding to two adjacent frames of preview images may have an adjacent or position proximity relationship in the sequence formed by the prompt words (partially same prompts may even exist). In this way, the plurality of frames of preview images formed can also have a logic consistent with the content description logic according to the content description logic of the target text.

In another possible implementation, in response to segmenting the target text into the plurality of text segments, and obtaining the prompt words corresponding to the text segments, for example, the prompt words respectively corresponding to the plurality of text segments are input into the content generation model, to obtain the preview images corresponding to the text segments.

In this case, there is an association relationship between a preview image corresponding to each text segment and a prompt word corresponding to the text segment.

Specifically, for a same segment of target text, when the content generation model obtains the preview images respectively corresponding to the plurality of text segments by using the prompt words corresponding to the plurality of text segments, if there is only one target scenario described in the target text, target scenarios presented in the plurality of frames of preview images may be same scenarios, and have same or similar scenario layout features; and if there is also only one target role described in the target text, target roles presented in the plurality of frames of preview images may also be same roles, and usually have same appearance features.

In another embodiment of the present disclosure, before the preview image is generated, the method further includes:

acquiring painting style information and/or image ratio information of the preview image.

In this case, the inputting the prompt word into a content generation model, and generating at least one frame of preview image corresponding to the target text specifically includes: inputting at least one selected from the group consisting of the painting style information and the image ratio information, and the prompt word into the content generation model, and generating the preview image corresponding to the target text.

Herein, the painting style information, for example, includes a specific style of the generated preview image, and includes, for example, at least one of the following: ancient wash painting, category A comics, category B comics, oil painting, realist line drawing, and the like. This may be specifically selected according to an actual requirement.

In addition, the image ratio information is used to describe an aspect ratio of a preview image, for example, includes at least one of the following: 3:4, 4:3, 9:16, and 16:9.

The foregoing painting style information and image ratio information may both be determined according to an actual requirement. This is not limited in this embodiment of the present disclosure.

When the foregoing painting style information, image ratio information, and candidate timbres are displayed, for example, a specific example may be further displayed to the user, so that the user can learn more about the related information visually, thereby making it convenient for the user to make a choice.

In another embodiment of the present disclosure, after the preview image is generated, the method may further include: displaying the preview image in an interactive control page.

When the preview images are displayed, for examples, thumbnails of the preview images may be displayed in the interactive control page in a sequence between text segments. The user may tap the thumbnails of the preview images, to trigger to display the preview images in a zoom-in manner.

In another embodiment, when a plurality of frames of preview images are displayed, text segments and/or prompt words corresponding to the preview images may be further displayed in an associated manner.

Herein, when a prompt word associated with a particular preview image includes a scenario prompt word and a role prompt word, when the prompt word is displayed, the scenario prompt word may be distinguished from the role prompt word for separate display, so that the user can better learn features respectively corresponding to the target scenario and the target role.

In addition, in another embodiment, appearance features of the target role may be further set in advance, and are not based only on appearance features of the target role that are obtained through parsing based on the target text.

Further, in the content generation method provided in this embodiment of the present disclosure, before the at least one frame of preview image corresponding to the target text is generated, the method further includes:

obtaining appearance feature information corresponding to the target role, wherein the appearance feature information is obtained by performing role feature analysis on the target text, and/or receiving the appearance feature information corresponding to the target role input by a user;

inputting the appearance feature information into the content generation model, to obtain a role image of the target role; and

the inputting the prompt word into a content generation model, and generating at least one frame of preview image corresponding to the target text includes:

inputting the prompt word and the role image into the content generation model, to generate the at least one frame of preview image corresponding to the target text.

In this way, for example, the appearance feature information of the target role includes, for example: role A: square face with big eyes, masculine expression, thick and long eyebrows, roman nose, thin and comely lips, and untrimmed beard.

In this way, after the appearance feature information is input into the content generation model, the content generation model can generate a character setting graph of the target role based on the appearance feature information, and the character setting graph can match the appearance feature information. In this way, the user can directly set the character setting of the target role, to determine appearance of the target role, thereby increasing interactive control by the user over the content generation process.

In addition, the method provided in this embodiment of the present disclosure further includes:

in response to a second modification operation on the appearance feature information corresponding to the target role, generating a new role image of the target role based on a modified appearance feature information;

determining a preview image corresponding to the target role from a plurality of preview images; and

modifying the target role in the preview image corresponding to the target role based on the new role image, to obtain a second preview image;

the generating target multimedia content corresponding to the target text based on the new preview image, comprising:

generating the target multimedia content corresponding to the target text based on the second preview image and the new preview image.

In this way, a role image can be quickly modified, to make it convenient for the user to modify a character setting of the target role before the target multimedia content is generated.

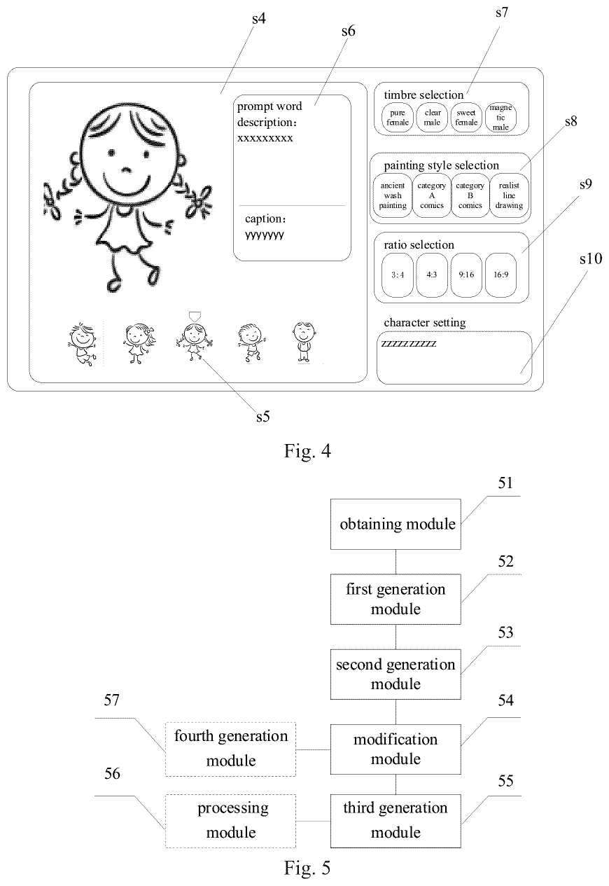

In the example shown in FIG. 4, a specific example of an interactive control page during preview image display is shown. In this example, there are five frames of preview images determined for the target text, where thumbnails corresponding to the five frames of preview images are sequentially arranged and displayed in a first region s4 of the interactive control page.

In addition, to enable the user to view details of the preview images clearly, any frame of preview image may be further triggered for zoom-in display.

After the user triggers a thumbnail of the third frame of preview image s5, the third frame of preview image s5 is highlighted (in this example, highlighting is performed through mark adding, and the preview image triggered by the user may be further highlighted in manners such as highlighting and blush), and a prompt word s6 associated with the third frame of preview image is displayed in a first region of the interactive control page.

The prompt word s6 is displayed in an editable control, to facilitate receiving modification of the user on the prompt word, thereby adjusting the currently selected preview image in a targeted manner.

In addition, caption information may be further displayed in a control for displaying the prompt word, where the caption information may be, for example, editable content.

In addition, a timbre selection control s7, a painting style selection control s8, a ratio selection control s9, and a character setting control s10 are further displayed in a second region of the interactive control page.

The timbre selection control s7 includes a plurality of candidate timbres, including: pure female, clear male, sweet female, and magnetic male. The user may select a timbre therefrom, to determine a dubbing timbre for the target multimedia content. For details, reference may be made to the description of the following S105, and details are not described herein again.

The painting style selection control s8 includes a plurality of candidate painting styles, and includes: ancient wash painting, category A comics, category B comics, and realist line drawing; and the user may select painting style information of the target multimedia content therefrom.

The ratio selection control s9 includes a plurality of candidate ratios: 3:4, 4:3, 9:16, and 16:9 respectively. The user may select ratio information of the preview image from the candidate ratios.

The character setting control s10 is a control on which the user can input and edit content, to facilitate the user in adjusting the character setting of the target role in time.

In another possible implementation, during preview image display, only one preview image may alternatively be displayed. In addition, a preview image replacing control is further disposed in the interactive control page. The user may trigger the replacing control, to replace the currently displayed preview image with another preview image.

For the foregoing S104:

the first modification operation on the prompt word corresponding to any frame of text segment may have, for example, the following cases:

b1: if the to-be-modified preview image is associated only with the role prompt word, in this case, the first modification operation may be performed only on the role prompt word.

b2: if the to-be-modified preview image is associated only with the scenario prompt word, in this case, the first modification operation may be performed only on the scenario prompt word.

b3: if the to-be-modified preview image is associated with both the role prompt word and the scenario prompt word, the first modification operation may be performed only on the role prompt word, or the first modification operation may be performed only on the scenario prompt word; and in addition, the first modification operation may also be performed on both the role prompt word and the scenario prompt word.

After the modified prompt word is obtained, the modified prompt word is input into the content generation model, to generate a new preview image corresponding to the to-be-modified frame of preview image.

For a case of inputting prompt words respectively corresponding to the plurality of text segments into the content generation model, to obtain preview images corresponding to the text segments, the following manner may be used as an example:

in response to a first modification operation on a prompt word associated with any text segment, inputting a modified prompt word to the any text segment into the content generation model, and generating a new preview image corresponding to the any text segment.

Then, the new preview image may be displayed for the user in the interactive control page, and the modified prompt word is displayed in an associated manner.

Herein, when the modified prompt word is displayed, to enable the user to display a modification condition of the prompt word more clearly, a specific position of modification and/or specific content of modification may be further marked in the displayed modified prompt word.

In addition, a cancel button may be further displayed in the interactive control page. In response to a trigger operation on the cancel button, modification on the preview image corresponding to the any text segment is canceled, so that the modified preview image is recovered to a state before modification.

In this case, a modification record of modification on the preview image corresponding to the any text segment may be further kept. The modification record includes preview images newly generated during all previous modifications on preview images corresponding to the text segments, and prompt words corresponding to the newly generated preview images. Modification records are listed and displayed through the interactive page, so that the user can select a preview image to be used during generation of the target multimedia content.

In addition, in many cases, different preview images of a same target text have strong correlation with each other. Therefore, in some cases, the user not only needs to modify one frame of preview image therein, but also needs to perform uniform modification on a plurality of frames of preview images with correlation therein. Therefore, to perform uniform modification on the plurality of frames of preview images with correlation, another embodiment of the present disclosure further includes:

determining an associated preview image from other preview images other than the first preview image based on the modified prompt word corresponding to the any text segment; and

modifying the associated preview image based on the modified prompt word corresponding to the any text segment, to obtain a new preview image corresponding to the associated preview image.

Herein, when the associated preview image is determined, for example, if the modified prompt word indicates modification of appearance of the target role in comparison with the prompt word before modification, for example, “red hair” in appearance description is modified into “blue hair”, or a layout of the target scenario is modified, for example, the target scenario of event occurrence is modified from “a small oasis in the desert” to “populus euphratica forest in the desert”, the preview image needs to be modified in all target scenarios corresponding to the event. In this case, the associated preview image may be automatically determined based on the foregoing process, and the associated preview image is also modified based on the modified prompt word.

In addition, to further increase controllability of the user in the content generation process, after the associated preview image is determined, the associated preview image may be further marked in the interactive control page to the user. The user may further adjust the associated preview image according to the mark, for example, adjust the associated preview image into a non-associated preview image, or adjust the non-associated preview image into the associated preview image. Then, the associated preview image is modified only in response to a modification confirmation operation of the user, to obtain a new preview image corresponding to the associated preview image.

When the associated preview image is modified based on the modified prompt word, for example, the prompt word corresponding to the associated preview image may be adjusted based on the modified prompt word corresponding to the any frame of preview image, to obtain the modified prompt word corresponding to the associated preview image. Then, the modified prompt word corresponding to the associated preview image is input into the content generation module, to obtain the new preview image corresponding to the associated preview image.

Specifically, when the prompt word corresponding to the associated preview image is adjusted based on the modified prompt word corresponding to the any frame of preview image, to obtain the modified prompt word corresponding to the associated preview image, for example, the prompt word before modification that corresponds to the any frame of preview image may be matched with the prompt word corresponding to the associated preview image, to obtain a same prompt word or similar prompt word of the two; and then the modified prompt word corresponding to the any frame of preview image is synchronized to the same prompt word or the similar prompt word, to further obtain the modified prompt word corresponding to the associated preview image.

For the foregoing S105:

when the target multimedia content corresponding to the target text is generated based on the new preview image, for example, the preview image may be inserted into a preconfigured multimedia content template, to obtain the target multimedia content.

In another embodiment of the present disclosure, before the generating target multimedia content corresponding to the target text based on the new preview image, for example, the method may further include:

generating caption information corresponding to the target text, and/or determining a target timbre corresponding to the target text.

In this case, when the target multimedia content is generated, the target multimedia content corresponding to the target text may be generated based on at least one selected from the group consisting of the caption information and the target timbre and based on the preview image.

During specific implementation, when the caption information is generated, for example, the text segments may be directly used as the caption information.

In addition, operations such as person view conversion, refinement of languages, and filtering of redundant information are further performed on the text segments, to obtain the caption information.

d1: conversion for person views:

A description person view of the target text may include, for example, a first person view or a third person view. When the target text is in the first person view, the text segments may be converted from the first person view to the third person view according to actual application requirements; or when the target text is in the third person view, the text segments may be converted from the third person view to the first person view according to actual application requirements, to obtain the caption information.

d2: refinement for languages:

For example, language refinement may be performed on a long text segment, to obtain a segment of text that can express the complete meaning of the text segment more accurately and concisely, and the segment of text is used as the caption information.

d3: filtering of redundant information:

For example, when the target text includes a script, there is a lot of content for describing scenario layouts, role positioning, and the like. The content is more used to guide generation of a plurality of preview pictures, and the caption content is more used to reflect dialogues between different roles, a monologue of a particular role, and the like. In this case, content for describing the scenario layouts, role positioning, and the like may be filtered out as to-be-filtered redundant information, and the caption information is generated by using the dialogue content or the monologue content included in the script.

When the target timbre is determined, for example, at least one of the following manners may be used but this application is not limited thereto:

e1: determining a sound feature of the target role based on the target text, and matching a corresponding target timbre for the target role based on the sound feature.

Specifically, the sound feature may be reflected, for example, according to features of the target role in dimensions such as age, gender, and personality. A plurality of candidate timbres may be preset. A plurality of labels may be pre-determined for the candidate timbres. Content recorded in the label is used to indicate a feature that should be owned by a role corresponding to the candidate timbre.

After the sound feature of the target role is determined based on the target text, the sound feature may be separately matched with the labels of the candidate timbres, to select a candidate timbre that matches the timbre feature most as the target timbre.

e2: receiving a target timbre determined by a user from a plurality of candidate timbres.

Specifically, for example, a plurality of target timbres may be displayed for the user in the interactive control page. Before the target multimedia content is generated, the user may select any one of the displayed multiple of target timbres as the target timbre.

In addition, the target timbre may also be determined in another manner. Details are not described again in this embodiment of the present disclosure.

A person skilled in the art may understand that, in the foregoing methods of specific implementations, the order in which the steps are written does not means a strict order of execution, and does not constitute any limitation on the implementation process, and the specific order of execution of the steps should be determined by functions and possible internal logic of the steps.

Based on a same inventive concept, an embodiment of the present disclosure further provides a content generation apparatus corresponding to the content generation method. Because the apparatus in this embodiment of the present disclosure resolves the problem in a principle similar to that of the foregoing content generation method in embodiments of the present disclosure, for the implementation of the apparatus, reference may be made to the implementation of the method, and details are not described again.

FIG. 5 is a schematic diagram of a content generation apparatus according to an embodiment of the present disclosure. The apparatus includes:

an obtaining module 51, configured to acquire a target text, where the target text includes description content for describing a target role and/or a target scenario;

a first generation module 52, configured to generate a prompt word based on the target text, where the prompt word includes: a role prompt word corresponding to the target role and/or a scenario prompt word corresponding to the target scenario;

a second generation module 53, configured to: input the prompt word into a content generation model, and generate at least one frame of preview image corresponding to the target text, where prompt words associated with different preview images are at least partially different;

a modification module 54, configured to: in response to a first modification operation on a prompt word associated with a first preview image, input a modified prompt word into the content generation model, and generate a new preview image corresponding to the first preview image, wherein the first preview image is any one frame of the at least one frame of preview image; and

a third generation module 55, configured to generate target multimedia content corresponding to the target text based on the new preview image.

In a possible implementation, when inputs the prompt word into the content generation model, and generates the at least one frame of preview image corresponding to the target text, the second generation module 53 is configured to:

input prompt words respectively corresponding to the plurality of text segments into the content generation model, to obtain preview images corresponding to the text segments.

In a possible implementation, when inputs the modified prompt word into the content generation model in response to the first modification operation on the prompt word associated with a first image, and generates the new preview image corresponding to the first preview image, the modification module 54 is configured to:

in response to a first modification operation on a prompt word associated with any text segment, input a modified prompt word corresponding to the any text segment into the content generation model, and generate a new preview image corresponding to the any text segment.

In a possible implementation, the modification module 54 is further configured to: determine an associated preview image from other preview images other than the first preview image based on the modified prompt word corresponding to the any text segment; and

modify the associated preview image based on the modified prompt word corresponding to the any text segment, to obtain a new preview image corresponding to the associated preview image.

In a possible implementation, the apparatus further includes: a processing module 56, configured to generate caption information corresponding to the target text, and/or determine a target timbre corresponding to the target text; and

when generating the target multimedia content corresponding to the target text based on the new preview image, the third generation module 55 is configured to:

generate the target multimedia content corresponding to the target text based on at least one selected from the group consisting of the caption information and the target timbre and based on the new preview image.

In a possible implementation, when determining the target timbre corresponding to the target text, the processing module 56 is configured to:

determine a sound feature of the target role based on the target text, and match the corresponding target timbre for the target role based on the sound feature; or,

receive the target timbre determined by a user from a plurality of candidate timbres.

In a possible implementation, the processing module 56 is further configured to: acquire painting style information and/or image ratio information of the preview image; and

when inputting the prompt word into the content generation model, and generating the at least one frame of preview image corresponding to the target text, the second generation module 53 is configured to:

input at least one selected from the group consisting of the painting style information and the image ratio information, and the prompt word into the content generation model, and generate the at least one frame of preview image corresponding to the target text.

In a possible implementation, the apparatus further includes: a fourth generation module 57, configured to:

obtain appearance feature information corresponding to the target role, wherein the appearance feature information is obtained by performing role feature analysis on the target text, and/or receiving the appearance feature information corresponding to the target role input by a user;

input the appearance feature information into the content generation model, to obtain a role image of the target role; and

when inputting the prompt word into the content generation model, and

generating the at least one frame of preview image corresponding to the target text, the second generation module 53 is configured to:

input the prompt word and the role image into the content generation model, and generate the at least one frame of preview image corresponding to the target text.

In a possible implementation, the modification module 54 is further configured to: in response to a second modification operation on the appearance feature information corresponding to the target role, generate a new role image of the target role based on a modified appearance feature information;

determine a preview image corresponding to the target role from a plurality of preview images; and

modify the target role in the preview image corresponding to the target role based on the new role image, to obtain a second preview image;

the generating target multimedia content corresponding to the target text based on the new preview image, comprises:

generating the target multimedia content corresponding to the target text based on the second preview image and the new preview image.

Reference may be made to related descriptions in the foregoing method embodiment for descriptions of processing procedures of the modules in the apparatus, and procedures of interactions between the modules.

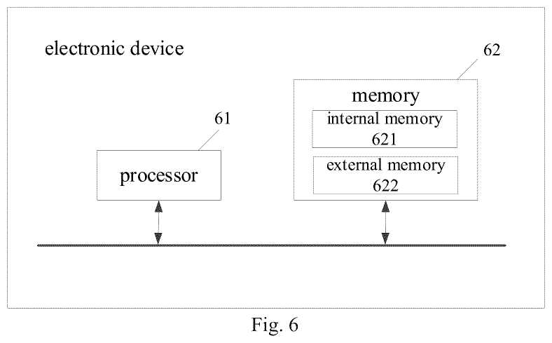

An embodiment of the present disclosure further provides a computer device. FIG. 6 is a schematic structural diagram of a computer device according to an embodiment of the present disclosure. The computer device includes:

a processor 61 and a memory 62, where the memory 62 stores a machine-readable instruction that can be executed by the processor 61, the processor 61 is configured to execute the machine-readable instruction stored in the memory 62, and when the machine-readable instruction is executed by the processor 61, the processor 61 performs the following steps:

acquiring a target text, where the target text includes description content for describing a target role and/or a target scenario;

generating a prompt word based on the target text, where the prompt word includes: a role prompt word corresponding to the target role and/or a scenario prompt word corresponding to the target scenario;

inputting the prompt word into a content generation model, and generating at least one frame of preview image corresponding to the target text, where prompt words associated with different preview images are at least partially different;

in response to a first modification operation on a prompt word associated with a first preview image, inputting a modified prompt word into the content generation model, and generating a new preview image corresponding to the first image; and

generating target multimedia content corresponding to the target text based on the preview image.

The memory 62 includes an internal memory 621 and an external memory 622. The internal memory 621 herein is also referred to as an inner memory, and is configured to temporarily store operational data in the processor 61, and data exchanged with the external memory 622 such as a hard disk. The processor 61 exchanges data with the external memory 622 by using the internal memory 621.

For a specific execution process of the foregoing instruction, reference may be made to the steps of the content generation method in the embodiments of the present disclosure. Details are not described herein again.

An embodiment of the present disclosure further provides a computer-readable storage medium, where the computer-readable storage medium stores a computer program, and when the computer program is executed by a processor, the steps of the content generation method in the forgoing method embodiments are performed. The storage medium may be a volatile or non-volatile computer-readable storage medium.

An embodiment of the present disclosure further provides a computer program product. The computer program product carries program code. Instructions included in the program code may be used to perform the steps of the content generation method in the foregoing method embodiments. Reference may be made to the foregoing method embodiments for details. Details are not described herein again.

The computer program product may be realized specifically by means of hardware, software or a combination thereof. In an optional embodiment, the computer program product is specifically embodied as a computer storage medium, and in another optional embodiment, the computer program product is specifically embodied as a software product, such as a software development kit (Software Development Kit, SDK) or the like.

It may be clearly understood by a person skilled in the art that, for the purpose of convenient and brief description, for a detailed working process of the system and apparatus described above, reference may be made to a corresponding process in the foregoing method embodiments. Details are not described herein again. In several embodiments provided in the present disclosure, it should be understood that the disclosed system, apparatus, and method may be implemented in another manner. The apparatus embodiments described above are merely examples. For example, division into the units is merely logic function division and may be other division in actual implementation. For another example, a plurality of units or components may be combined or integrated into another system, or some features may be ignored or not performed. In addition, the displayed or discussed mutual couplings or direct couplings or communication connections may be implemented by using some communication interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of embodiments.

In addition, functional units in embodiments of the present disclosure may be integrated into one processing unit, each of the units may exist alone physically, or two or more units are integrated into one unit.

When the functions are implemented in the form of a software functional unit and sold or used as an independent product, the functions may be stored in a nonvolatile computer-readable storage medium that can be executed by a processor. Based on such an understanding, the technical solutions of the present disclosure essentially, or the part contributing to the prior art, or some of the technical solutions may be implemented in a form of a software product. The software product is stored in a storage medium, and includes several instructions for instructing a computer device (which may be a personal computer, a server, or a network device) to perform all or some of the steps of the methods described in embodiments of the present disclosure. The foregoing storage medium includes: any medium that can store program code, for example, a USB flash drive, a removable hard disk, a read-only memory (Read-Only Memory, ROM), a random-access memory (Random Access Memory, RAM), a magnetic disk, or an optical disc.

Finally, it should be noted that the foregoing embodiments are merely specific implementations of the present disclosure, and are used to describe the technical solutions of the present disclosure, but not to limit the technical solutions of the present disclosure, and the protection scope of the present disclosure is not limited thereto. Although the present disclosure has been described in detail with reference to the foregoing embodiments, a person of ordinary skill in the art should understand that any person skilled in the art can still modify the technical solutions recorded in the foregoing embodiments, easily figure out changes, or equivalently replace some of the technical features therein within the technical scope disclosed in the present disclosure. However, these modifications, changes, or replacements do not make the essence of the corresponding technical solutions depart from the spirit and scope of the technical solutions of embodiments of the present disclosure, and should all be covered within the protection scope of the present disclosure. Therefore, the protection scope of the present disclosure shall be subject to the protection scope of the claims.

1. A content generation method, comprising:
acquiring a target text, wherein the target text comprises description content for describing a target role and/or a target scenario;
generating a prompt word based on the target text, wherein the prompt word comprises: a role prompt word corresponding to the target role and/or a scenario prompt word corresponding to the target scenario;
inputting the prompt word into a content generation model, and generating at least one frame of preview image corresponding to the target text, wherein prompt words associated with different preview images are at least partially different;
in response to a first modification operation on a prompt word associated with a first preview image, inputting a modified prompt word into the content generation model, and generating a new preview image corresponding to the first preview image, wherein the first preview image is any one frame of the at least one frame of preview image; and
generating target multimedia content corresponding to the target text based on the new preview image.

2. The content generation method according to claim 1, wherein the generating a prompt word based on the target text, comprises:
splitting the target text to obtain a plurality of text segments, wherein any text segment comprises: at least part of a first description content for the target role, and/or at least part of a second description content for the target scenario; and
for each text segment of the plurality of text segments, performing semantic analysis on each text segment to obtain a prompt word corresponding to each text segment.

3. The content generation method according to claim 2, wherein the inputting the prompt word into a content generation model, and generating at least one frame of preview image corresponding to the target text, comprises:
inputting prompt words respectively corresponding to the plurality of text segments into the content generation model, to obtain a preview image corresponding to each text segment.

4. The content generation method according to claim 3, wherein the in response to a first modification operation on a prompt word associated with a first preview image, inputting a modified prompt word into the content generation model, and generating a new preview image corresponding to the first preview image, comprises:
in response to a first modification operation on a prompt word associated with any text segment, inputting a modified prompt word corresponding to the any text segment into the content generation model, and generating a new preview image corresponding to the any text segment.

5. The content generation method according to claim 4, further comprising: determining an associated preview image from other preview images other than the first preview image based on the modified prompt word corresponding to the any text segment; and
modifying the associated preview image based on the modified prompt word corresponding to the any text segment, to obtain a new preview image corresponding to the associated preview image.

6. The content generation method according to claim 1, wherein before the generating target multimedia content corresponding to the target text based on the new preview image, the content generation method further comprises:
generating caption information corresponding to the target text, and/or determining a target timbre corresponding to the target text; and
the generating target multimedia content corresponding to the target text based on the new preview image, comprises:
generating the target multimedia content corresponding to the target text based on the new image and at least one selected from a group consisting of the caption information and the target timbre.

7. The content generation method according to claim 6, wherein the determining a target timbre corresponding to the target text, comprises:
determining a sound feature of the target role based on the target text, and matching a corresponding target timbre for the target role based on the sound feature; or,
receiving a target timbre determined by a user from a plurality of candidate timbres.

8. The content generation method according to claim 1, further comprising:
acquiring painting style information and/or image ratio information of the preview image; and
the inputting the prompt word into a content generation model, and generating at least one frame of preview image corresponding to the target text, comprises:
inputting the prompt word and at least one selected from the group consisting of the painting style information and the image ratio information into the content generation model, and generating the at least one frame of preview image corresponding to the target text.

9. The content generation method according to claim 1, wherein before the generating at least one frame of preview image corresponding to the target text, the method further comprises:
obtaining appearance feature information corresponding to the target role, wherein the appearance feature information is obtained by performing role feature analysis on the target text, and/or receiving the appearance feature information corresponding to the target role input by a user;
inputting the appearance feature information into the content generation model, to obtain a role image of the target role; and
the inputting the prompt word into a content generation model, and generating at least one frame of preview image corresponding to the target text, comprising:
inputting the prompt word and the role image into the content generation model to generate the at least one frame of preview image corresponding to the target text.

10. The content generation method according to claim 9, further comprising:
in response to a second modification operation on the appearance feature information corresponding to the target role, generating a new role image of the target role based on a modified appearance feature information;
determining a preview image corresponding to the target role from a plurality of preview images; and
modifying the target role in the preview image corresponding to the target role based on the new role image, to obtain a second preview image;
the generating target multimedia content corresponding to the target text based on the new preview image, comprising:
generating the target multimedia content corresponding to the target text based on the second preview image and the new preview image.

11. A computer device, comprising: a processor and a memory, wherein the memory stores machine-readable instructions executable by the processor, and the processor is configured to execute the machine-readable instructions stored in the memory, the machine-readable instructions, when executed by the processor, cause the computer device to perform a content generation method, the content generation method comprises:
acquiring a target text, wherein the target text comprises description content for describing a target role and/or a target scenario;
generating a prompt word based on the target text, wherein the prompt word comprises: a role prompt word corresponding to the target role and/or a scenario prompt word corresponding to the target scenario;
inputting the prompt word into a content generation model, and generating at least one frame of preview image corresponding to the target text, wherein prompt words associated with different preview images are at least partially different;
in response to a first modification operation on a prompt word associated with a first preview image, inputting a modified prompt word into the content generation model, and generating a new preview image corresponding to the first preview image, wherein the first preview image is any one frame of the at least one frame of preview image; and
generating target multimedia content corresponding to the target text based on the new preview image.

12. The computer device according to claim 11, wherein the generating a prompt word based on the target text, comprises:
splitting the target text to obtain a plurality of text segments, wherein any text segment comprises: at least part of a first description content for the target role, and/or at least part of a second description content for the target scenario; and
for each text segment of the plurality of text segments, performing semantic analysis on each text segment to obtain a prompt word corresponding to each text segment.

13. The computer device according to claim 12, wherein the inputting the prompt word into a content generation model, and generating at least one frame of preview image corresponding to the target text, comprises:
inputting prompt words respectively corresponding to the plurality of text segments into the content generation model, to obtain a preview image corresponding to each text segment.

14. The computer device according to claim 13, wherein the in response to a first modification operation on a prompt word associated with a first preview image, inputting a modified prompt word into the content generation model, and generating a new preview image corresponding to the first preview image, comprises:
in response to a first modification operation on a prompt word associated with any text segment, inputting a modified prompt word corresponding to the any text segment into the content generation model, and generating a new preview image corresponding to the any text segment.

15. The computer device according to claim 14, wherein the machine-readable instructions, when executed by the processor, further cause the computer device to:
determine an associated preview image from other preview images other than the first preview image based on the modified prompt word; and
modify the associated preview image based on the modified prompt word, to obtain a new preview image corresponding to the associated preview image.

16. The computer device according to claim 11, wherein before the generating target multimedia content corresponding to the target text based on the preview image, the machine-readable instructions, when executed by the processor, further cause the computer device to:
generate caption information corresponding to the target text, and/or determine a target timbre corresponding to the target text; and
the generating target multimedia content corresponding to the target text based on the new preview image, comprises:
generating the target multimedia content corresponding to the target text based on the new image and at least one selected from a group consisting of the caption information and the target timbre.

17. The computer device according to claim 16, wherein the determining a target timbre corresponding to the target text, comprises:
determining a sound feature of the target role based on the target text, and matching a corresponding target timbre for the target role based on the sound feature; or,
receiving a target timbre determined by a user from a plurality of candidate timbres.

18. The computer device according to claim 11, wherein the machine-readable instructions, when executed by the processor, further cause the computer device to:
acquire painting style information and/or image ratio information of the preview image; and
the inputting the prompt word into a content generation model, and generating at least one frame of preview image corresponding to the target text, comprises:
inputting the prompt word and at least one selected from the group consisting of the painting style information and the image ratio information into the content generation model, and generating the at least one frame of preview image corresponding to the target text.

19. The computer device according to claim 11, wherein before the generating at least one frame of preview image corresponding to the target text, the machine-readable instructions, when executed by the processor, further cause the computer device to:
obtain appearance feature information corresponding to the target role, wherein the appearance feature information is obtained by performing role feature analysis on the target text, and/or receive the appearance feature information corresponding to the target role input by a user;
input the appearance feature information into the content generation model, to obtain a role image of the target role; and
the inputting the prompt word into a content generation model, and generating at least one frame of preview image corresponding to the target text, comprising:
inputting the prompt word and the role image into the content generation model to generate the at least one frame of preview image corresponding to the target text.

20. A non-transient computer-readable storage medium, wherein the non-transient computer-readable storage medium stores computer programs, the computer programs, when executed by a computer device, cause the computer device to perform a content generation method, the content generation method comprises:
acquiring a target text, wherein the target text comprises description content for describing a target role and/or a target scenario;
generating a prompt word based on the target text, wherein the prompt word comprises: a role prompt word corresponding to the target role and/or a scenario prompt word corresponding to the target scenario;
inputting the prompt word into a content generation model, and generating at least one frame of preview image corresponding to the target text, wherein prompt words associated with different preview images are at least partially different;
in response to a first modification operation on a prompt word associated with a first preview image, inputting a modified prompt word into the content generation model, and generating a new preview image corresponding to the first preview image, wherein the first preview image is any one frame of the at least one frame of preview image; and
generating target multimedia content corresponding to the target text based on the new preview image.
